(19) United States
(12) Patent Application Publication
(10) Pub. No.: US 2023/0283789 A1
(43) Pub. Date: Sep. 7, 2023

(54) EFFICIENT HYPERTEXT TRANSFER PROTOCOL (HTTP) ADAPTIVE BITRATE (ABR) STREAMING BASED ON SCALABLE VIDEO CODING (SVC)

(71) Applicant: Intel Corporation, Santa Clara, CA (US)

(72) Inventors: Gang Shen, Hillsboro, OR (US); Ce Wang, Bellevue, WA (US); Guangxin Xu, Shanghai (CN); Jianhua Wu, Santa Clara, CA (US)

(21) Appl. No.: 18/317,380

(22) Filed: May 15, 2023

Related U.S. Application Data
(60) Provisional application No. 63/342,483, filed on May 16, 2022.

(51) Int. Cl. H04N 19/30; H04N 19/172; H04N 19/115

(52) U.S. Cl. CPC H04N 19/30; H04N 19/172; H04N 19/115

(57) ABSTRACT

Various embodiments herein provide techniques related to a content provider in a network. In embodiments, the content provider may identify a request by a client over the network for content; identify a network bandwidth; and transmit, based on the network bandwidth, (1) a base layer of the content without an enhanced layer of the content, or (2) the base layer of the content and the enhanced layer of the content. Other embodiments may be described and/or claimed.

### CROSS REFERENCE TO RELATED APPLICATION

The present application claims priority to U.S. Provisional Patent Application No. 63/342,483, which was filed May 16, 2022; the disclosure of which is hereby incorporated by reference.

### FIELD

Various embodiments generally may relate to the field of content streaming.

### BACKGROUND

Various embodiments generally may relate to the field of wireless communications.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example of hypertext transfer protocol (HTTP) adaptive bit rate (ABR) streaming, in accordance with various embodiments.

FIG. 2 illustrates an example of scalable video coding (SVC), in accordance with various embodiments.

FIG. 3 illustrates an example of layer rendition delivery, in accordance with various embodiments.

FIG. 4 illustrates an example of a SVC structure for HTTP ABR streaming, in accordance with various embodiments.

FIG. 5 illustrates an example of an HTTP ABR end-to-end delivery pipeline, in accordance with various embodiments.

FIG. 6 schematically illustrates a wireless network in accordance with various embodiments.

FIG. 7 schematically illustrates components of a wireless network in accordance with various embodiments.

FIG. 8 is a block diagram illustrating components, according to some example embodiments, able to read instructions from a machine-readable or computer-readable medium (e.g., a non-transitory machine-readable storage medium) and perform any one or more of the methodologies discussed herein.

FIG. 9 depicts an example procedure for practicing the various embodiments discussed herein.

FIG. 10 depicts another example procedure for practicing the various embodiments discussed herein.

FIG. 11 depicts another example procedure for practicing the various embodiments discussed herein.

FIG. 12 depicts another example procedure for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

Hypertext transfer protocol (HTTP) Adaptive Bitrate (ABR) streaming protocols support the major media streaming traffic on today's internet and content delivery network(s) (CDN(s)). Examples of such protocols may include or relate to: Apple's® HTTP Live Streaming (HLS), the Moving Picture Experts Group (MPEG) Dynamic Adaptive Streaming over HTTP (DASH), MPEG Common Media Application Format (CMAF), etc.

The common characteristics among these protocols may include one or more of the following: 1) Deliver segments of contents—a series of small files, by consecutive HTTP pull requests; 2) Prepare/encode content segments into multiple tracks, based on bitrates or resolutions, to allow client's pull requests adaptive to the current network conditions; 3) Use a manifest file to declare the organization of segment files for each period.

While those protocols may serve the linear streaming very well, they may share common challenges in low latency use scenarios. For example, the segment/file size (e.g., which may relate to content segments with a length on the order of 6 seconds) may dictate the granularity of the client's pull operations. For example, one or both of the following may be true:
1) The client usually buffers at least one segment—to prepare for the potential network jitters, before starting the rendering.
2) The switch between different tracks must happen at the beginning of the segments.

The first issue related to buffering may result in a long startup time. The second issue related to switching may create challenges when switching channels or switching bitrate tracks—Those events may not be handled immediately when they happens in the middle of one segment time; the switching must occur at the boundary of segments. In short, in current HTTP ABR streaming, to get an instantaneous decoder refresh (IDR) frame means to fetch a new segment which is costly in the cases of starting up, channel switch and bitrate switch.

From the encoding industry, SVC (Scalable Video Coding) may offer a layered bitstream structure that can be potentially transported in separated channel. Therefore, it may allow for a more efficient HTTP ABR streaming with SVC. Various codecs may support SVC, such as, H.264, High Efficiency Video Coding (HEVC), AOMedia Video 1 (AV1), Versatile Video Coding (VVC), etc. Embodiments herein relate to a design to extend current HTTP ABR streaming with SVC. Embodiments may be implemented and/or compatible with various codecs, and may offer advantages in terms of less bandwidth consumed and more efficient processing.

Legacy solutions to the above-described issues may generally rely on reducing segment size and encoding GOP (Group of Picture) size in implementations, as long as the network condition allows. For examples, CMAF may allow shortened segments (e.g., on the order of 1 second). However, the bitrate of the content will be inevitably increased due to each short segment will have an IDR frames. Specifically, IDR frames are significantly larger in bit size.

Another attempt to resolve the above-described issues is an AV1 S-frame (switch frame), which allows lower resolution track can reuse the decoding buffer of high resolution track, so that track switch can happen at such frames without the need of IDR frames. The drawback of this approach is it will introduce artifacts and S-frames cannot make every frame as a switch point.

Both approaches have not completely resolved the track switch issue. As a result, some embodiments may relate to a coding structure based on SVC and anchor frames, as well as a new delivery protocol based on HTTP ABR. This combination may make a more flexible and more efficient video delivery over HTTP (Pull requests).

Example Overview of SVC-Based HTTP ABR Streaming

HTTP ABR streaming protocols (e.g., HTTP Live Streaming (HLS), DASH, CMAF, etc.) are client-based protocols that may conduct consecutive HTTP pulls of a series of file segments from server. A client may monitor the network conditions (like bandwidth) and decide to pull the appropriate “rendition” of next segments. For each file segment, different “renditions” (e.g., segments that include the same base content but vary from one another based on characteristics such as bitrate, resolution, frames per second (fps), etc.) will be encoded and packed in advance, so that the content can be delivered through various network conditions and to heterogenous devices. A collection of renditions may be referred to as a “bitrate ladder”.

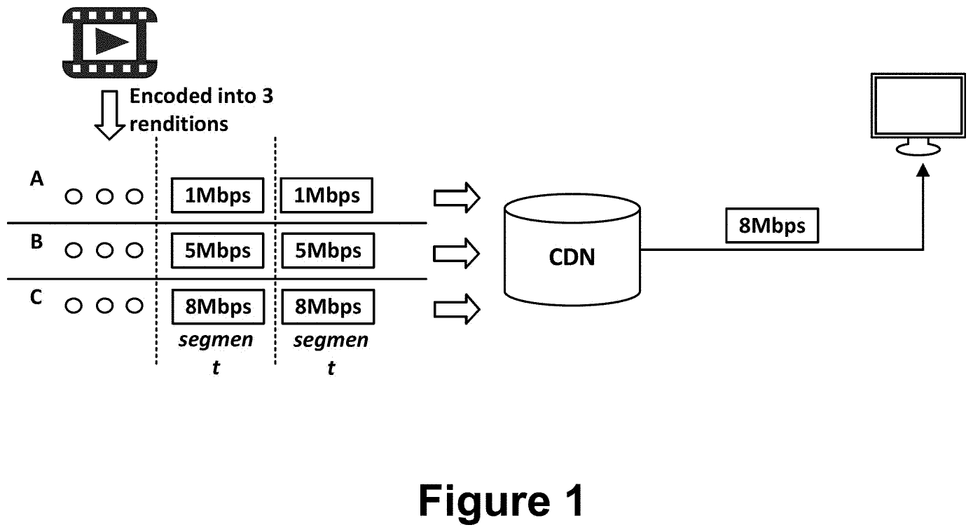

One example of “bitrate ladder” is shown in FIG. 1: each segment of 1080p video may be encoded into 3 renditions (files) of bitrates of 1 Megabit per second (Mbps), 5 Mbps, 8 Mbps respectively—“bit rate ladder”. At the current moment, the client in the diagram pulls an 8 Mbps rendition (a segment in track C) from the CDN—now the network condition can support high bitrate content.

When network condition deteriorates, the client (in FIG. 1) can switch to track A or B—i.e., pull segments from tracks of lower bitrates, so that the content decoding and rendering will be smooth (with certain visual quality loss).

Although HTTP ABR may allow the client to select/switch the rendition to appropriate bitrates, this selection/switch may only be allowed at the boundary of each segment file. This is one reason that causes the quality and latency problems of HTTP ABR streaming. There may therefore be two outstanding issues to consider: A) It needs a way to allow decoding process to continue between tracks; B) It needs a way to fetch partial content of a segment. A layered encoding structure and a byte-range HTTP protocol will be a perfect fit for A) and B).

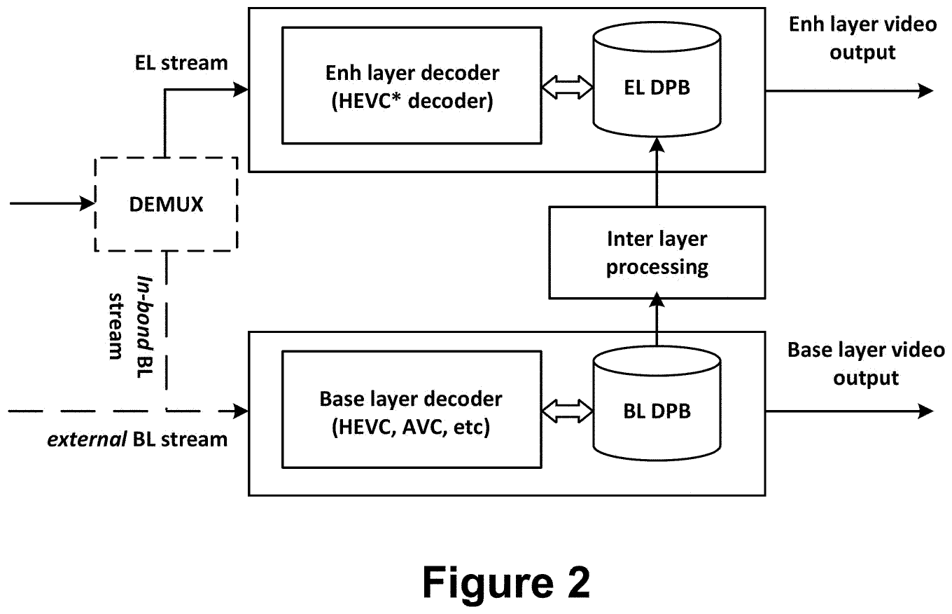

The layered structure of scalable video coding (SVC) may have the flexibility of encoding video content into multiple layers and transporting layers separately. FIG. 2 shows an example high-level concept of SVC decoder of H.265 (SHVC).

The encoding of enhanced layer (EL) in SVC may rely on the base layer—i.e., it is an encoding of the residual frames from base layer (BL). Therefore, the track switch in ABR streaming could be considered as bitstream switching: the base layer is always transmitted, and one (or none) of the enhanced layers gets transmitted according to the network bandwidth. To put in another way, the “bitrate ladder” in ABR can be constructed by bitrate of each layer.

To use the example in FIG. 1 to illustrate, the “bitrate ladder” may be constructed by “bitrate layers”, where the base layer (A′) and enhanced layers (B′, C′) can offer the same bitrate ladder as that in FIG. 1:

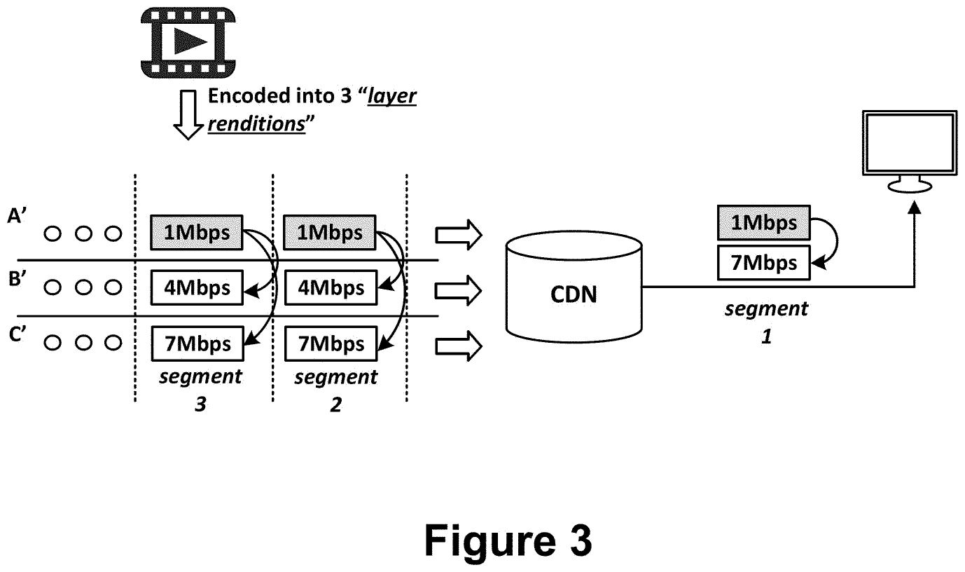

TABLE 1
New Bitrate Ladder based on SVC

| Conventional HTTP | Bitrate Ladder |
|---|---|
| ABR Bitrate | herein |
| Ladder (FIG. 1) | (FIG. 3) |
| 1 Mbps (A) | 1 Mbps (A') |
| 5 Mbps (B) | 5 Mbps (A' + B') |
| 8 Mbps (C) | 8 Mbps (A' + C') |

Correspondently, the HTTP ABR process can be revised to pull one or two “layer renditions” according to network conditions. When network bandwidth is low, an HTTP ABR client can pull only base layer rendition (e.g., A′ track in FIG. 3); when network bandwidth is high enough, HTTP ABR client can pull one base layer rendition and one enhanced layer rendition (e.g., A′ and C′ layer renditions are pulled for the segment1 in FIG. 3).

Overall, the SVC-based HTTP ABR Streaming can be built as:
1) Use SVC layered coding schema on video contents, and make “layer renditions”—i.e., pack each layer into file segments for HTTP ABR streaming.
2) The enhanced layers of SVC in use will have cross-layer dependencies. To facilitate fast layer switch, it is designed to have cross-layer dependencies all on base layer.
3) The client will pull base layer rendition and one of the enhanced layer renditions according to network condition and the configuration of client devices (such as resolutions).
4) Apply HTTP Byte-Range Request on enhanced layers, which allows client to issue specific byte-range in a HTTP pull request—i.e., pull enhanced layer from any positions. This will help instantaneous track switch; the switch can happen in any frames.

The SVC encoding of content will outperform the multiple encodings of the same content for usual HTTP ABR transcoding processes—more efficiently. The layered packing of SVC bitstream structure can provide not only the flexibility of HTTP ABR, but also the chances of network QoS optimizations: since the base layer is always being pulled and critical for decoding of all other layers, it is possible and practical to apply a specific network QoS just on the channel of base layer—this is not possible to apply different network QoS setting in current HTTP ABR streaming of one content. It is worthy to note that CDN caching strategy may become more efficient when there is a “ladder of priority” available, as described above.

There may be different designs of SVC-based bitstream schema that can be used as parts of embodiments herein. In the following sections, one example of SVC bitstream structure is provided to showcase the flexibility and efficiency of embodiments herein. AV1 is used in example while the schemas applicable to other modern codecs (such as VVC, LCEVC, etc.) as well.

An Example SVC Bitstream Structure with Instantaneous Bitrate Switch in HTTP ABR

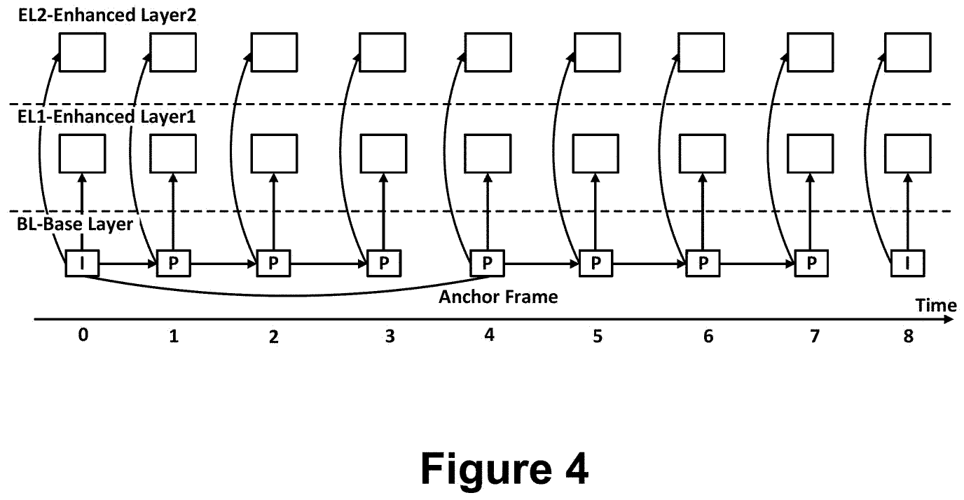

SVC offers great flexibility for content to be encoded and rendered in different qualities or different resolutions, in which layers (of SVC) can serve the purpose of tracks in HTTP ABR. There could be different designs of SVC structures for HTTP ABR. In this section, an example SVC structure, with balanced the coding efficiency and reduced HTTP ABR track switch latency, is presented in FIG. 4.

Aspects of this embodiment may include one or more of:
1) Enhanced layers are coded with spatial dependency on base layer—i.e., base layer has lower resolution, where frames in enhanced layers are coded correspondently higher resolutions.
2) Frames in enhanced layer have dependency only to frames (of the same timestamp) in base layer.
3) Anchor frames are used only in base layer to reduce the session join latency.

Each layer in FIG. 4 may be packed into “layer renditions” (i.e., segment files). The base layer (“BL”) renditions will be pulled all the time and one of the enhanced layer renditions may be pulled when network condition is allowed. EL1 can be correspondent to layer rendition B′ and EL2 to C′ in FIG. 3.

GOP size 8 in base layer may be used in FIG. 4 for easy illustration, but larger GOP size can be applied in actual usage for better compression ratio. The anchor frames, which depends only on the IDR frame in a GOP, can be inserted at equal intervals and those can help to reduce the session join latency, because it can segment big GOP into many “sub-GOP”—like (0,1,2,3) and (4,5,6,7) two sub-GOPs in FIG. 4. The maximum session join latency will the length of those sub-GOPs.

The bitrate change (i.e., the bitrate adaptation), can happen conveniently at any frame (at any time) by selecting the appropriate EL. The total bandwidth to use will be:

Bandwidth to use=Bandwidth of BL+Bandwidth of selected EL

When network is in poor condition, no EL will be selected and only BL is transported.

The client will pull the base layer all the time. When network condition becomes improved, client can pull frames from one of the enhanced layers at any time, decode and render the higher resolution content immediately. There is no need to wait for IDR frames. For example, client can start to pull non-IDR Frame 3 in EL1 and decode together with non-IDR Frame 3 in BL for a better-quality frame instantaneously, when network condition allows.

The down-bitrate switch can be easily achieved as well: the client can downscale the bitrate from the highest bitrate combination (EL2+BL) to medium bitrate combination (EL1+BL) or lowest bitrate (BL) at any frame.

It will be noted that, in accordance with various embodiments herein and as may be seen in FIG. 4, anchor frames may shorten the length between an IDR frame and various dependent frames within one segment and/or rendition.

Changes to Legacy HTTP ABR Protocols.

As shown above, with SVC, the encoded content can be organized into various bitrate layers—a natural “bitrate ladder”. It can naturally save the storage because each layer is only about the differences from base layer, compared with current HTTP ABR protocols (MPEG-DASH, HLS, CMAF) where each track is a bitstream of complete content.

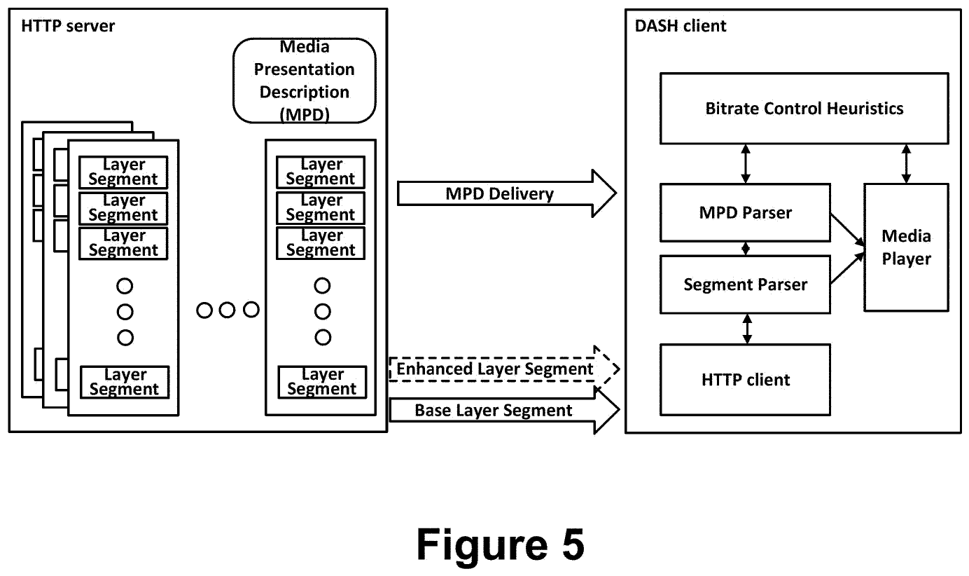

Accordingly, to accommodate layered bitstreams in SVC, there are a few changes to make in HTTP ABR streaming (shown in FIG. 5) protocols. MPEG-DASH will be used for illustration while the same changes can be implemented into other HTTP ABR protocols (like HLS, CMAF, etc).

Certain of the modules in FIG. 5 (e.g., the MPD, the MPD parser, the segment parser, etc.) may be similar to those defined by the MPEG-DASH standard. The modules and data flows marked with orange color will have extensions to accommodate the SVC bitstreams described herein. Those changes may be considered extensions to legacy HTTP ABR frameworks.

The list of changes may include one or more of:
1) The manifest file of HTTP ABR (MPD in MPEG-DASH) will have “Layer Representation” to denote layer renditions (layer segments in the FIG. 5).

MPD is an XML format file to denote all content segments for client to adaptively pull according to network conditions. To facilitate SVC layered bitstream, the “<AdaptationSet>” in MPD can set up new XML tags “<LayerRepresentation>”—currently MPEG-DASH uses “<Representation>” to represent tracks. It is worthy to note other MPD tags and structures can be reused without changes.

Below is an example of new MPD “<AdaptationSet>”, which includes 3 layered renditions (for the content in FIG. 3).

```
<AdaptationSet id=”1” segmentAlignment=”true” maxWidth=”1920”
maxHeight=”1080” maxFrameRate=”24” par=”1920:800” lang=”eng”
startWithSAP=”1”>
    <LayerRepresentation id=”1” mimeType=”video/mp4/base” codecs=”av1”
  width=”1920” height=”1080” bandwidth=”1000000”>
    <LayerRepresentation>
      <LayerRepresentation id=”2” mimeType=”video/mp4/el1” codecs=”av1”
  width=”1920” height=”1080” bandwidth=”4000000” refer-id=”1”>...
    <LayerRepresentation>
      <LayerRepresentation id=”3” mimeType=”video/mp4/el2” codecs=”av1”
  width=”1920” height=”1080” bandwidth=”7000000” refer-id=”1”>...
    <LayerRepresentation>
<AdaptationSet>
```

The tag “<LayerRepresentation>” is to denote layer renditions/segments used in an Adaptation Set. The attribute “refer-id” is to indicate the layer rendition has a dependency on base layer rendition, which is marked by id=“1,” and base layer has no “refer-id”.
2) Accordingly, “Layer Segment” files will pack the SVC bitstream layers on the server side; “MPD Parser” and “Segment Parser” in client will be able to get the layered structure information.
3) In HTTP ABR protocols, the client controls heuristics to adapt to dynamic network conditions. Based on the heuristics and layered representations, the client shall pull segments from multiple layers (at most 2 layers) from server. The base layer segments will always be pulled, which is different from current HTTP ABR client executions.

The consistent transport of base layer described herein may also present an opportunity of applying different QoS settings for video content in HTTP network traffic—i.e., the base layer traffic can be set and transported with higher priority or even premium channels. Potentially, CDN caching algorithm enhance QoS by prioritizing base layer in network cache.

### SUMMARY

Scalable video coding (SVC) is an important feature of modern codecs. Embodiments herein may be aligned SVC's layered bitstream structure with “bitrate ladder” of HTTP ABR streaming and provided a flexible approach to utilize SVC and optimize HTTP ABR streaming. This approach will not only reduce the latency of bitrate track switching in HTTP ABR streaming, but also opens new opportunities of optimizations of CDN caching and layered network QoS.

It will be noted that, although SVC is used for the sake of describing various embodiments herein, one or more other codecs may additionally or alternatively be used. For example, advanced video coding (AVC) may be used in some embodiments for the base layer. Additionally or alternatively, versatile video coding (VVC) may provide a resolution and/or bitrate requirement that are appropriate for use as one or more of the higher layers (e.g., the non-base layers). In some embodiments, a single codec may be used for all layers, while in other embodiments different codecs may be used for different ones of the layers.

### Systems and Implementations

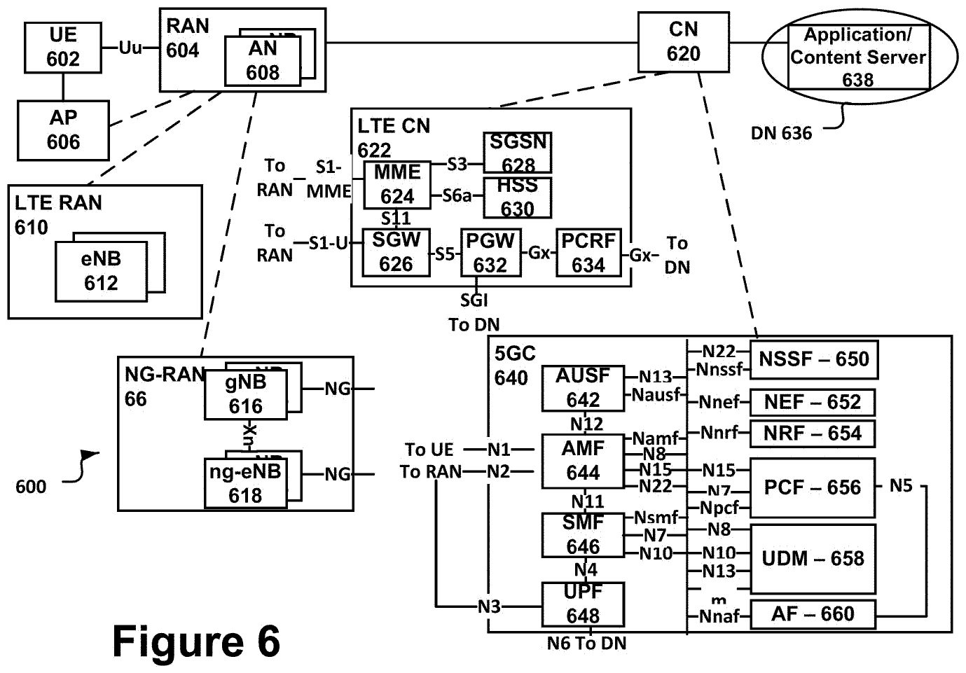

FIGS. 6-8 illustrate various systems, devices, and components that may implement aspects of disclosed embodiments.

FIG. 6 illustrates a network 600 in accordance with various embodiments. The network 600 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 600 may include a UE 602, which may include any mobile or non-mobile computing device designed to communicate with a RAN 604 via an over-the-air connection. The UE 602 may be communicatively coupled with the RAN 604 by a Uu interface. The UE 602 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 600 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 602 may additionally communicate with an AP 606 via an over-the-air connection. The AP 606 may manage a WLAN connection, which may serve to offload some/all network traffic from the RAN 604. The connection between the UE 602 and the AP 606 may be consistent with any IEEE 802.11 protocol, wherein the AP 606 could be a wireless fidelity (Wi-Fi®) router. In some embodiments, the UE 602, RAN 604, and AP 606 may utilize cellular-WLAN aggregation (for example, LWA/LWIP). Cellular-WLAN aggregation may involve the UE 602 being configured by the RAN 604 to utilize both cellular radio resources and WLAN resources.

The RAN 604 may include one or more access nodes, for example, AN 608. AN 608 may terminate air-interface protocols for the UE 602 by providing access stratum protocols including RRC, PDCP, RLC, MAC, and L1 protocols. In this manner, the AN 608 may enable data/voice connectivity between CN 620 and the UE 602. In some embodiments, the AN 608 may be implemented in a discrete device or as one or more software entities running on server computers as part of, for example, a virtual network, which may be referred to as a CRAN or virtual baseband unit pool. The AN 608 be referred to as a BS, gNB, RAN node, eNB, ng-eNB, NodeB, RSU, TRxP, TRP, etc. The AN 608 may be a macrocell base station or a low power base station for providing femtocells, picocells or other like cells having smaller coverage areas, smaller user capacity, or higher bandwidth compared to macrocells.

In embodiments in which the RAN 604 includes a plurality of ANs, they may be coupled with one another via an X2 interface (if the RAN 604 is an LTE RAN) or an Xn interface (if the RAN 604 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 604 may each manage one or more cells, cell groups, component carriers, etc. to provide the UE 602 with an air interface for network access. The UE 602 may be simultaneously connected with a plurality of cells provided by the same or different ANs of the RAN 604. For example, the UE 602 and RAN 604 may use carrier aggregation to allow the UE 602 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 604 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 602 or AN 608 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 604 may be an LTE RAN 610 with eNBs, for example, eNB 612. The LTE RAN 610 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 604 may be an NG-RAN 614 with gNBs, for example, gNB 616, or ng-eNBs, for example, ng-eNB 618. The gNB 616 may connect with 5G-enabled UEs using a 5G NR interface. The gNB 616 may connect with a 5G core through an NG interface, which may include an N2 interface or an N3 interface. The ng-eNB 618 may also connect with the 5G core through an NG interface, but may connect with a UE via an LTE air interface. The gNB 616 and the ng-eNB 618 may connect with each other over an Xn interface.

In some embodiments, the NG interface may be split into two parts, an NG user plane (NG-U) interface, which carries traffic data between the nodes of the NG-RAN 614 and a UPF 648 (e.g., N3 interface), and an NG control plane (NG-C) interface, which is a signaling interface between the nodes of the NG-RAN614 and an AMF 644 (e.g., N2 interface).

The NG-RAN 614 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 602 can be configured with multiple BWPs where each BWP configuration has a different SCS. When a BWP change is indicated to the UE 602, the SCS of the transmission is changed as well. Another use case example of BWP is related to power saving. In particular, multiple BWPs can be configured for the UE 602 with different amount of frequency resources (for example, PRBs) to support data transmission under different traffic loading scenarios. A BWP containing a smaller number of PRBs can be used for data transmission with small traffic load while allowing power saving at the UE 602 and in some cases at the gNB 616. A BWP containing a larger number of PRBs can be used for scenarios with higher traffic load.

The RAN 604 is communicatively coupled to CN 620 that includes network elements to provide various functions to support data and telecommunications services to customers/subscribers (for example, users of UE 602). The components of the CN 620 may be implemented in one physical node or separate physical nodes. In some embodiments, NFV may be utilized to virtualize any or all of the functions provided by the network elements of the CN 620 onto physical compute/storage resources in servers, switches, etc. A logical instantiation of the CN 620 may be referred to as a network slice, and a logical instantiation of a portion of the CN 620 may be referred to as a network sub-slice.

In some embodiments, the CN 620 may be an LTE CN 622, which may also be referred to as an EPC. The LTE CN 622 may include MME 624, SGW 626, SGSN 628, HSS 630, PGW 632, and PCRF 634 coupled with one another over interfaces (or “reference points”) as shown. Functions of the elements of the LTE CN 622 may be briefly introduced as follows.

The MME 624 may implement mobility management functions to track a current location of the UE 602 to facilitate paging, bearer activation/deactivation, handovers, gateway selection, authentication, etc.

The SGW 626 may terminate an S1 interface toward the RAN and route data packets between the RAN and the LTE CN 622. The SGW 626 may be a local mobility anchor point for inter-RAN node handovers and also may provide an anchor for inter-3GPP mobility. Other responsibilities may include lawful intercept, charging, and some policy enforcement.

The SGSN 628 may track a location of the UE 602 and perform security functions and access control. In addition, the SGSN 628 may perform inter-EPC node signaling for mobility between different RAT networks; PDN and S-GW selection as specified by MME 624; MME selection for handovers; etc. The S3 reference point between the MME 624 and the SGSN 628 may enable user and bearer information exchange for inter-3GPP access network mobility in idle/active states.

The HSS 630 may include a database for network users, including subscription-related information to support the network entities' handling of communication sessions. The HSS 630 can provide support for routing/roaming, authentication, authorization, naming/addressing resolution, location dependencies, etc. An S6a reference point between the HSS 630 and the MME 624 may enable transfer of subscription and authentication data for authenticating/authorizing user access to the LTE CN 620.

The PGW 632 may terminate an SGi interface toward a data network (DN) 636 that may include an application/content server 638. The PGW 632 may route data packets between the LTE CN 622 and the data network 636. The PGW 632 may be coupled with the SGW 626 by an S5 reference point to facilitate user plane tunneling and tunnel management. The PGW 632 may further include a node for policy enforcement and charging data collection (for example, PCEF). Additionally, the SGi reference point between the PGW 632 and the data network 6 36 may be an operator external public, a private PDN, or an intra-operator packet data network, for example, for provision of IMS services. The PGW 632 may be coupled with a PCRF 634 via a Gx reference point.

The PCRF 634 is the policy and charging control element of the LTE CN 622. The PCRF 634 may be communicatively coupled to the app/content server 638 to determine appropriate QoS and charging parameters for service flows. The PCRF 632 may provision associated rules into a PCEF (via Gx reference point) with appropriate TFT and QCI.

In some embodiments, the CN 620 may be a 5GC 640. The 5GC 640 may include an AUSF 642, AMF 644, SMF 646, UPF 648, NSSF 650, NEF 652, NRF 654, PCF 656, UDM 658, and AF 660 coupled with one another over interfaces (or “reference points”) as shown. Functions of the elements of the 5GC 640 may be briefly introduced as follows.

The AUSF 642 may store data for authentication of UE 602 and handle authentication-related functionality. The AUSF 642 may facilitate a common authentication framework for various access types. In addition to communicating with other elements of the 5GC 640 over reference points as shown, the AUSF 642 may exhibit an Nausf service-based interface.

The AMF 644 may allow other functions of the 5GC 640 to communicate with the UE 602 and the RAN 604 and to subscribe to notifications about mobility events with respect to the UE 602. The AMF 644 may be responsible for registration management (for example, for registering UE 602), connection management, reachability management, mobility management, lawful interception of AMF-related events, and access authentication and authorization. The AMF 644 may provide transport for SM messages between the UE 602 and the SMF 646, and act as a transparent proxy for routing SM messages. AMF 644 may also provide transport for SMS messages between UE 602 and an SMSF. AMF 644 may interact with the AUSF 642 and the UE 602 to perform various security anchor and context management functions. Furthermore, AMF 644 may be a termination point of a RAN CP interface, which may include or be an N2 reference point between the RAN 604 and the AMF 644; and the AMF 644 may be a termination point of NAS (N1) signaling, and perform NAS ciphering and integrity protection. AMF 644 may also support NAS signaling with the UE 602 over an N3 IWF interface.

The SMF 646 may be responsible for SM (for example, session establishment, tunnel management between UPF 648 and AN 608); UE IP address allocation and management (including optional authorization); selection and control of UP function; configuring traffic steering at UPF 648 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 644 over N2 to AN 608; and determining SSC mode of a session. SM may refer to management of a PDU session, and a PDU session or “session” may refer to a PDU connectivity service that provides or enables the exchange of PDUs between the UE 602 and the data network 636.

The UPF 648 may act as an anchor point for intra-RAT and inter-RAT mobility, an external PDU session point of interconnect to data network 636, and a branching point to support multi-homed PDU session. The UPF 648 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 648 may include an uplink classifier to support routing traffic flows to a data network.

The NSSF 650 may select a set of network slice instances serving the UE 602. The NSSF 650 may also determine allowed NSSAI and the mapping to the subscribed S-NSSAIs, if needed. The NSSF 650 may also determine the AMF set to be used to serve the UE 602, or a list of candidate AMFs based on a suitable configuration and possibly by querying the NRF 654. The selection of a set of network slice instances for the UE 602 may be triggered by the AMF 644 with which the UE 602 is registered by interacting with the NSSF 650, which may lead to a change of AMF. The NSSF 650 may interact with the AMF 644 via an N22 reference point; and may communicate with another NSSF in a visited network via an N31 reference point (not shown). Additionally, the NSSF 650 may exhibit an Nnssf service-based interface.

The NEF 652 may securely expose services and capabilities provided by 3GPP network functions for third party, internal exposure/re-exposure, AFs (e.g., AF 660), edge computing or fog computing systems, etc. In such embodiments, the NEF 652 may authenticate, authorize, or throttle the AFs. NEF 652 may also translate information exchanged with the AF 660 and information exchanged with internal network functions. For example, the NEF 652 may translate between an AF-Service-Identifier and an internal 5GC information. NEF 652 may also receive information from other NFs based on exposed capabilities of other NFs. This information may be stored at the NEF 652 as structured data, or at a data storage NF using standardized interfaces. The stored information can then be re-exposed by the NEF 652 to other NFs and AFs, or used for other purposes such as analytics. Additionally, the NEF 652 may exhibit an Nnef service-based interface.

The NRF 654 may support service discovery functions, receive NF discovery requests from NF instances, and provide the information of the discovered NF instances to the NF instances. NRF 654 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 654 may exhibit the Nnrf service-based interface.

The PCF 656 may provide policy rules to control plane functions to enforce them, and may also support unified policy framework to govern network behavior. The PCF 656 may also implement a front end to access subscription information relevant for policy decisions in a UDR of the UDM 658. In addition to communicating with functions over reference points as shown, the PCF 656 exhibit an Npcf service-based interface.

The UDM 658 may handle subscription-related information to support the network entities' handling of communication sessions, and may store subscription data of UE 602. For example, subscription data may be communicated via an N8 reference point between the UDM 658 and the AMF 644. The UDM 658 may include two parts, an application front end and a UDR. The UDR may store subscription data and policy data for the UDM 658 and the PCF 656, and/or structured data for exposure and application data (including PFDs for application detection, application request information for multiple UEs 602) for the NEF 652. The Nudr service-based interface may be exhibited by the UDR 221 to allow the UDM 658, PCF 656, and NEF 652 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 658 may exhibit the Nudm service-based interface.

The AF 660 may provide application influence on traffic routing, provide access to NEF, and interact with the policy framework for policy control.

In some embodiments, the 5GC 640 may enable edge computing by selecting operator/3rd party services to be geographically close to a point that the UE 602 is attached to the network. This may reduce latency and load on the network. To provide edge-computing implementations, the 5GC 640 may select a UPF 648 close to the UE 602 and execute traffic steering from the UPF 648 to data network 636 via the N6 interface. This may be based on the UE subscription data, UE location, and information provided by the AF 660. In this way, the AF 660 may influence UPF (re)selection and traffic routing. Based on operator deployment, when AF 660 is considered to be a trusted entity, the network operator may permit AF 660 to interact directly with relevant NFs. Additionally, the AF 660 may exhibit an Naf service-based interface.

The data network 636 may represent various network operator services, Internet access, or third party services that may be provided by one or more servers including, for example, application/content server 638.

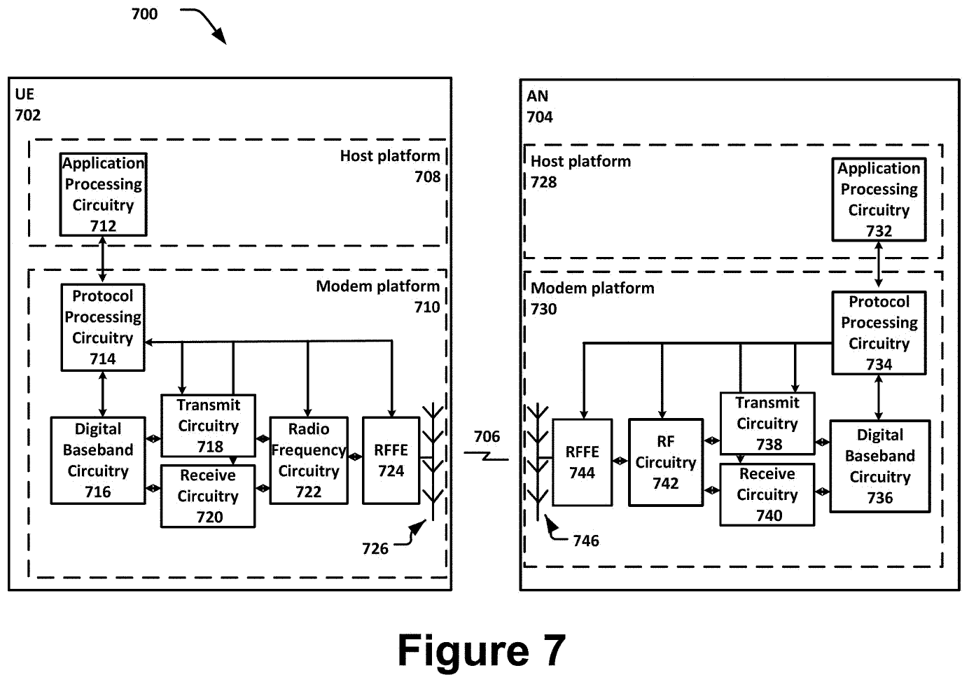

FIG. 7 schematically illustrates a wireless network 700 in accordance with various embodiments. The wireless network 700 may include a UE 702 in wireless communication with an AN 704. The UE 702 and AN 704 may be similar to, and substantially interchangeable with, like-named components described elsewhere herein.

The UE 702 may be communicatively coupled with the AN 704 via connection 706. The connection 706 is illustrated as an air interface to enable communicative coupling, and can be consistent with cellular communications protocols such as an LTE protocol or a 5G NR protocol operating at mmWave or sub-6 GHz frequencies.

The UE 702 may include a host platform 708 coupled with a modem platform 710. The host platform 708 may include application processing circuitry 712, which may be coupled with protocol processing circuitry 714 of the modem platform 710. The application processing circuitry 712 may run various applications for the UE 702 that source/sink application data. The application processing circuitry 712 may further implement one or more layer operations to transmit/receive application data to/from a data network. These layer operations may include transport (for example UDP) and Internet (for example, IP) operations

The protocol processing circuitry 714 may implement one or more of layer operations to facilitate transmission or reception of data over the connection 706. The layer operations implemented by the protocol processing circuitry 714 may include, for example, MAC, RLC, PDCP, RRC and NAS operations.

The modem platform 710 may further include digital baseband circuitry 716 that may implement one or more layer operations that are “below” layer operations performed by the protocol processing circuitry 714 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 710 may further include transmit circuitry 718, receive circuitry 720, RF circuitry 722, and RF front end (RFFE) 724, which may include or connect to one or more antenna panels 726. Briefly, the transmit circuitry 718 may include a digital-to-analog converter, mixer, intermediate frequency (IF) components, etc.; the receive circuitry 720 may include an analog-to-digital converter, mixer, IF components, etc.; the RF circuitry 722 may include a low-noise amplifier, a power amplifier, power tracking components, etc.; RFFE 724 may include filters (for example, surface/bulk acoustic wave filters), switches, antenna tuners, beamforming components (for example, phase-array antenna components), etc. The selection and arrangement of the components of the transmit circuitry 718, receive circuitry 720, RF circuitry 722, RFFE 724, and antenna panels 726 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 714 may include one or more instances of control circuitry (not shown) to provide control functions for the transmit/receive components.

A UE reception may be established by and via the antenna panels 726, RFFE 724, RF circuitry 722, receive circuitry 720, digital baseband circuitry 716, and protocol processing circuitry 714. In some embodiments, the antenna panels 726 may receive a transmission from the AN 704 by receive-beamforming signals received by a plurality of antennas/antenna elements of the one or more antenna panels 726.

A UE transmission may be established by and via the protocol processing circuitry 714, digital baseband circuitry 716, transmit circuitry 718, RF circuitry 722, RFFE 724, and antenna panels 726. In some embodiments, the transmit components of the UE 704 may apply a spatial filter to the data to be transmitted to form a transmit beam emitted by the antenna elements of the antenna panels 726.

Similar to the UE 702, the AN 704 may include a host platform 728 coupled with a modem platform 730. The host platform 728 may include application processing circuitry 732 coupled with protocol processing circuitry 734 of the modem platform 730. The modem platform may further include digital baseband circuitry 736, transmit circuitry 738, receive circuitry 740, RF circuitry 742, RFFE circuitry 744, and antenna panels 746. The components of the AN 704 may be similar to and substantially interchangeable with like-named components of the UE 702. In addition to performing data transmission/reception as described above, the components of the AN 708 may perform various logical functions that include, for example, RNC functions such as radio bearer management, uplink and downlink dynamic radio resource management, and data packet scheduling.

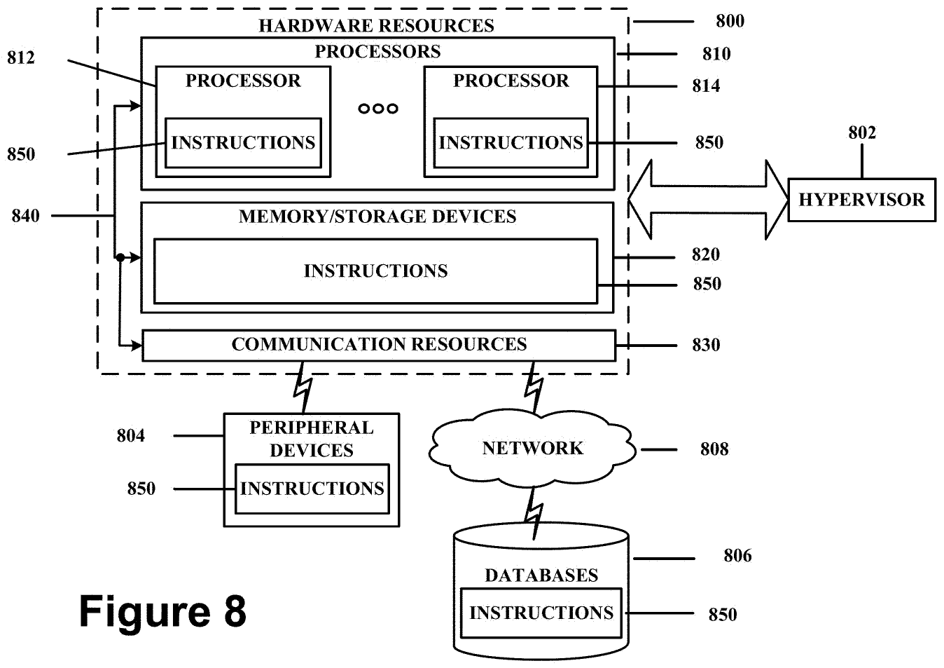

FIG. 8 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 8 shows a diagrammatic representation of hardware resources 800 including one or more processors (or processor cores) 810, one or more memory/storage devices 820, and one or more communication resources 830, each of which may be communicatively coupled via a bus 840 or other interface circuitry. For embodiments where node virtualization (e.g., NFV) is utilized, a hypervisor 802 may be executed to provide an execution environment for one or more network slices/sub-slices to utilize the hardware resources 800.

The processors 810 may include, for example, a processor 812 and a processor 814. The processors 810 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 820 may include main memory, disk storage, or any suitable combination thereof. The memory/storage devices 820 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 830 may include interconnection or network interface controllers, components, or other suitable devices to communicate with one or more peripheral devices 804 or one or more databases 806 or other network elements via a network 808. For example, the communication resources 830 may include wired communication components (e.g., for coupling via USB, Ethernet, etc.), cellular communication components, NFC components, Bluetooth® (or Bluetooth® Low Energy) components, Wi-Fi® components, and other communication components.

Instructions 850 may comprise software, a program, an application, an applet, an app, or other executable code for causing at least any of the processors 810 to perform any one or more of the methodologies discussed herein. The instructions 850 may reside, completely or partially, within at least one of the processors 810 (e.g., within the processor's cache memory), the memory/storage devices 820, or any suitable combination thereof. Furthermore, any portion of the instructions 850 may be transferred to the hardware resources 800 from any combination of the peripheral devices 804 or the databases 806. Accordingly, the memory of processors 810, the memory/storage devices 820, the peripheral devices 804, and the databases 806 are examples of computer-readable and machine-readable media.

### Example Procedures

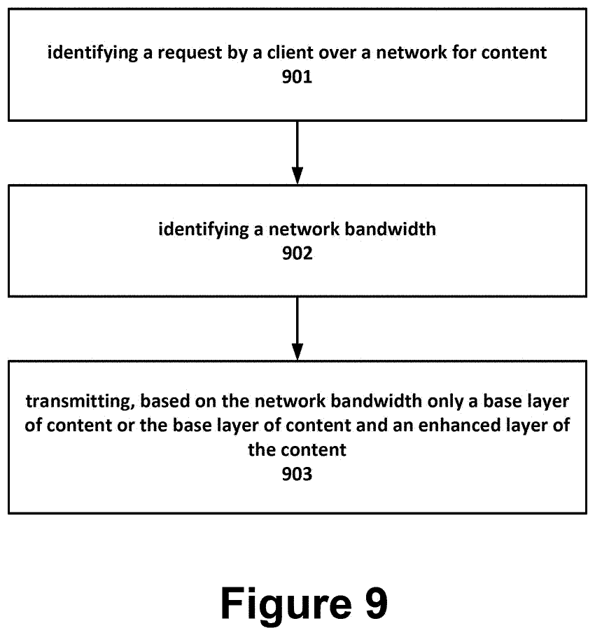

In some embodiments, the electronic device(s), network(s), system(s), chip(s) or component(s), or portions or implementations thereof, of FIGS. 6-8, or some other figure herein, may be configured to perform one or more processes, techniques, or methods as described herein, or portions thereof. One such process is depicted in FIG. 9. The process of FIG. 9 may relate to a method to be performed by a content provider, one or more elements of a content provider, and/or an electronic device that includes or implements a content provider. The process may include identifying, at 901, a request by a client over a network for content; identifying, at 902, a network bandwidth; and transmitting, at 903 based on the network bandwidth only a base layer of content or the base layer of content and an enhanced layer of the content.

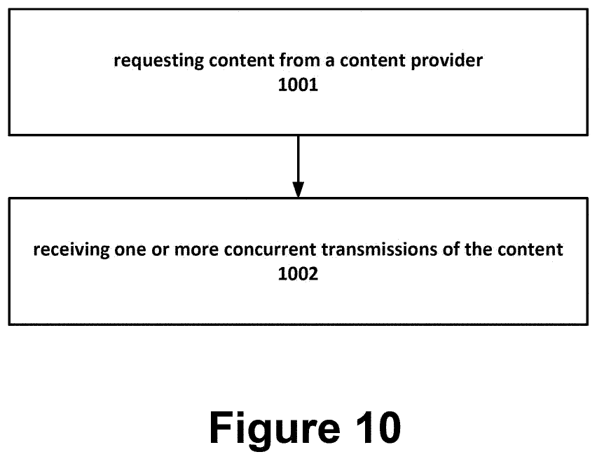

Another such process is depicted in FIG. 10. The process of FIG. 10 may relate to a method to be performed by a client in a network, one or more elements of the client, or an electronic device that includes and/or implements such a client. The process may include requesting, at 1001, content from a content provider; and receiving, at 1002, one or more concurrent transmissions of the content. In some embodiments, the number of concurrent transmissions of the content are based on a bandwidth of the network.

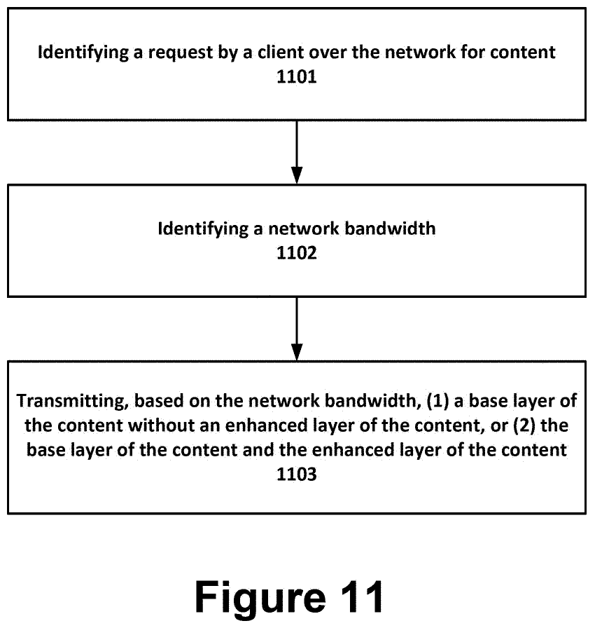

Another such process is depicted in FIG. 11. The process of FIG. 11 may relate to or include a method to be performed by a content provider in a network. The process may include, identifying, at 1101, a request by a client over the network for content; identifying, at 1102, a network bandwidth; and transmitting, at 1103 based on the network bandwidth, (1) a base layer of the content without an enhanced layer of the content, or (2) the base layer of the content and the enhanced layer of the content.

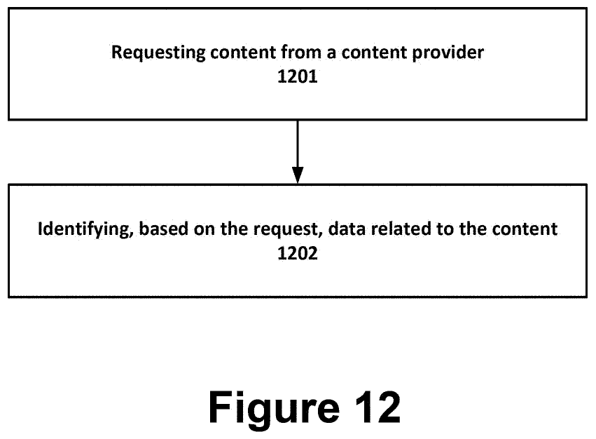

Another such process is depicted in FIG. 12. The process of FIG. 12 may relate to or include a method to be performed by a client in a network. The process may include requesting, at 1201, content from a content provider; and identifying, at 1202 based on the request, data related to the content; wherein, based on the bandwidth of the network, the data includes (1) a base layer of the content without an enhanced layer of the content, or (2) the base layer of the content and the enhanced layer of the content.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 may include using SVC (Scalable Video Coding) in HTTP ABR (Adaptive BitRate) streaming. Encoded video content in layered structure and each layer is transmitted via HTTP request. Multiple layers of the same content are transmitted in concurrent HTTP channels.

Example 2 may include base layer of encoded video content is always transmitted, where one or more enhanced layers of the same video content will be selectively transmitted along with base layer.

Example 3 may include the selection of enhanced layers are based on network condition and the bitrate of the enhanced layer, so that the total bitrate is adaptive to the network.

Example 4 may include the SVC coding structure with anchor frames is introduced to construct flexible switch points across multi-layers. The switch points allow client to conveniently switch between layers of different quality, which has been a chronicle problem in today's HTTP ABR streaming (such as, MPEG DASH).—6.1.B

Example 5 may include based on SVC and anchor frame, an enhanced HTTP ABR streaming pipeline (client/server) that support “Layered Renditions” is claimed—6.1.A, FIG. 3. The new addition “Layer Representation” in HTTP ABR manifest file are claimed—6.1.C.

Example 6 we also claimed layered video content are more suitable for layered network transports, which allow prioritizations of QoS of network transport aligned with quality levels of video content. Compared with the legacy approach—encode the same content into different quality copies, this approach can enhance the efficiency of encoding and network transport and reduce storage usage.

Example 7 may include a method to be performed by a content provider, one or more elements of a content provider, and/or an electronic device that includes or implements a content provider, wherein the method comprises:
identifying a request by a client over a network for content;
identifying a network bandwidth; and
transmitting, based on the network bandwidth only a base layer of content or the base layer of content and an enhanced layer of the content.

Example 8 may include the method of example 7, and/or some other example herein, wherein the content is encoded in accordance with scalable video coding (SVC).

Example 9 may include the method of example 8, and/or some other example herein, wherein the SVC encoding includes anchor frames.

Example 10 may include the method of any of examples 7-9, and/or some other example herein, wherein the content is transmitted based on hypertext transfer protocol (HTTP) adaptive bitrate (ABR) streaming.

Example 11 may include the method of example 10, wherein the HTTP ABR protocol includes support for one or both of layered renditions and layered representation.

Example 12 may include the method of any of examples 7-11, and/or some other example herein, wherein the enhanced layer of content has a bit rate that is higher than that of the base layer of content.

Example 13 may include the method of any of examples 7-12, and/or some other example herein, wherein, if the base layer and the enhanced layer are transmitted, the base layer and enhanced layer are transmitted in concurrent communication channels.

Example 14 may include the method of any of examples 7-13, and/or some other example herein, wherein the enhanced layer is one of a plurality of enhanced layers that have respective bit rates that are higher than a bit rate of the base layer.

Example 15 may include a method to be performed by a client in a network, one or more elements of the client, or an electronic device that includes and/or implements such a client, wherein the method comprises:
requesting content from a content provider; and
receiving one or more concurrent transmissions of the content;
wherein the number of concurrent transmissions of the content are based on a bandwidth of the network.

Example 16 may include the method of example 15, and/or some other example herein, wherein the content is encoded in accordance with scalable video coding (SVC).

Example 17 may include the method of example 16, and/or some other example herein, wherein the SVC encoding includes anchor frames.

Example 18 may include the method of example 17, and/or some other example herein, wherein the method further comprises switching based on the anchor frames, between rendering of a base layer and rendering of an enhanced layer.

Example 19 may include the method of any of examples 15-18, and/or some other example herein, wherein the content is transmitted based on hypertext transfer protocol (HTTP) adaptive bitrate (ABR) streaming.

Example 20 may include the method of example 19, wherein the HTTP ABR protocol includes support for one or both of layered renditions and layered representation.

Example 21 may include the method of any of examples 15-20, and/or some other example herein, wherein the enhanced layer of content has a bit rate that is higher than that of the base layer of content.

Example 22 may include the method of any of examples 15-21, and/or some other example herein, wherein, if the base layer and the enhanced layer are transmitted, the base layer and enhanced layer are transmitted in concurrent communication channels.

Example 23 may include the method of any of examples 15-22, and/or some other example herein, wherein the enhanced layer is one of a plurality of enhanced layers that have respective bit rates that are higher than a bit rate of the base layer.

Example 24 includes a method to be performed by a content provider in a network, wherein the method comprises: identifying a request by a client over the network for content; identifying a network bandwidth; and transmitting, based on the network bandwidth, (1) a base layer of the content without an enhanced layer of the content, or (2) the base layer of the content and the enhanced layer of the content.

Example 25 includes the method of example 24, and/or some other example herein, wherein the content is encoded in accordance with scalable video coding (SVC).

Example 26 includes the method of example 25, and/or some other example herein, wherein the SVC encoding includes anchor frames.

Example 27 includes the method of any of examples 24-26, and/or some other example herein, wherein the content is transmitted based on hypertext transfer protocol (HTTP) adaptive bitrate (ABR) streaming.

Example 28 includes the method of example 27, and/or some other example herein, wherein the HTTP ABR protocol includes support for one or both of layered renditions and layered representation.

Example 29 includes the method of any of examples 24-28, and/or some other example herein, wherein the enhanced layer of the content has a bit rate that is higher than that of the base layer of content.

Example 30 includes the method of any of examples 24-29, and/or some other example herein, wherein, if the base layer and the enhanced layer are transmitted, the base layer and enhanced layer are transmitted in concurrent communication channels.

Example 31 includes the method of any of examples 24-30, and/or some other example herein, wherein the enhanced layer is one of a plurality of enhanced layers that have respective bit rates that are higher than a bit rate of the base layer.

Example 32 includes a method to be performed by a client in a network, wherein the method comprises: requesting content from a content provider; and identifying, based on the request, data related to the content; wherein, based on the bandwidth of the network, the data includes (1) a base layer of the content without an enhanced layer of the content, or (2) the base layer of the content and the enhanced layer of the content.

Example 33 includes the method of example 32, and/or some other example herein, wherein the content is encoded in accordance with scalable video coding (SVC).

Example 34 includes the method of example 33, and/or some other example herein, wherein the SVC encoding includes anchor frames.

Example 35 includes the method of any of examples 32-34, and/or some other example herein, wherein the content is transmitted based on hypertext transfer protocol (HTTP) adaptive bitrate (ABR) streaming.

Example 36 includes the method of example 35, and/or some other example herein, wherein the HTTP ABR protocol includes support for one or both of layered renditions and layered representation.

Example 37 includes the method of any of examples 32-36, and/or some other example herein, wherein the enhanced layer of the content has a bit rate that is higher than that of the base layer of the content.

Example 38 includes the method of any of examples 32-37, and/or some other example herein, wherein, if the base layer and the enhanced layer are transmitted, the base layer and enhanced layer are transmitted in concurrent communication channels.

Example 39 includes the method of any of examples 32-38, and/or some other example herein, wherein the enhanced layer is one of a plurality of enhanced layers that have respective bit rates that are higher than a bit rate of the base layer.

Example Z01 may include an apparatus comprising means to perform one or more elements of a method described in or related to any of examples 1-39, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-39, or any other method or process described herein.

Example Z03 may include an apparatus comprising logic, modules, or circuitry to perform one or more elements of a method described in or related to any of examples 1-39, or any other method or process described herein.

Example Z04 may include a method, technique, or process as described in or related to any of examples 1-39, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-39, or portions thereof.

Example Z06 may include a signal as described in or related to any of examples 1-39, or portions or parts thereof.

Example Z07 may include a datagram, packet, frame, segment, protocol data unit (PDU), or message as described in or related to any of examples 1-39, or portions or parts thereof, or otherwise described in the present disclosure.

Example Z08 may include a signal encoded with data as described in or related to any of examples 1-39, or portions or parts thereof, or otherwise described in the present disclosure.

Example Z09 may include a signal encoded with a datagram, packet, frame, segment, protocol data unit (PDU), or message as described in or related to any of examples 1-39, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-39, or portions thereof.

Example Z11 may include a computer program comprising instructions, wherein execution of the program by a processing element is to cause the processing element to carry out the method, techniques, or process as described in or related to any of examples 1-39, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

| | |
|---|---|
| 3GPP | Third Generation |
| | Partnership Project |
| 4G | Fourth Generation |
| 5G | Fifth Generation |
| 5GC | 5G Core network |
| AC | Application Client |
| ACR | Application |
| | Context Relocation |
| ACK | Acknowledgement |
| ACID | Application |
| | Client Identification |
| AF | Application Function |
| AM | Acknowledged Mode |
| AMBR | Aggregate |
| | Maximum Bit Rate |
| AMF | Access and Mobility |
| | Management Function |
| AN | Access Network |
| ANR | Automatic Neighbour |
| | Relation |
| AOA | Angle of Arrival |
| AP | Application Protocol, |
| | Antenna Port, Access |
| | Point |
| API | Application |
| | Programming Interface |
| APN | Access Point Name |
| ARP | Allocation and |
| | Retention Priority |
| ARQ | Automatic Repeat |
| | Request |
| AS | Access Stratum |
| ASP | Application |
| | Service Provider |
| ASN.1 | Abstract Syntax |
| | Notation One |
| AUSF | Authentication |
| | Server Function |
| AWGN | Additive White |
| | Gaussian Noise |
| BAP | Backhaul |
| | Adaptation Protocol |
| BCH | Broadcast Channel |
| BER | Bit Error Ratio |
| BFD | Beam Failure |
| | Detection |
| BLER | Block Error Rate |
| BPSK | Binary Phase Shift |
| | Keying |
| BRAS | Broadband Remote |
| | Access Server |
| BSS | Business Support |
| | System |
| BS | Base Station |
| BSR | Buffer Status Report |
| BW | Bandwidth |
| BWP | Bandwidth Part |
| C-RNTI | Cell Radio |
| | Network Temporary |
| | Identity |
| CA | Carrier |
| | Aggregation, |
| | Certification |
| | Authority |
| CAPEX | CAPital |
| | Expenditure |
| CBRA | Contention Based |
| | Random Access |
| CC | Component Carrier, |
| | Country Code, |
| | Cryptographic |
| | Checksum |
| CCA | Clear Channel |
| | Assessment |
| CCE | Control Channel |
| | Element |
| CCCH | Common Control |
| | Channel |
| CE | Coverage Enhancement |
| CDM | Content Delivery |
| | Network |
| CDMA | Code- |
| | Division Multiple |
| | Access |
| CDR | Charging Data |
| | Request |
| CDR | Charging Data |
| | Response |
| CFRA | Contention Free |
| | Random Access |
| CG | Cell Group |
| CGF | Charging |
| | Gateway Function |
| CHF | Charging |
| | Function |
| CI | Cell Identity |
| CID | Cell-ID (e.g., |
| | positioning method) |
| CIM | Common |
| | Information Model |
| CIR | Carrier to |
| | Interference Ratio |
| CK | Cipher Key |
| CM | Connection |
| | Management, Conditional |
| | Mandatory |
| CMAS | Commercial |
| | Mobile Alert Service |
| CMD | Command |
| CMS | Cloud Management |
| | System |
| CO | Conditional |
| | Optional |
| COMP | Coordinated Multi- |
| | Point |
| CORESET | Control |
| | Resource Set |
| COTS | Commercial Off- |
| | The-Shelf |
| CP | Control Plane, |
| | Cyclic Prefix, Connection |
| | Point |
| CPD | Connection Point |
| | Descriptor |
| CPE | Customer Premise |
| | Equipment |
| CPICH | Common Pilot |
| | Channel |
| CQI | Channel Quality |
| | Indicator |
| CPU | CSI processing |
| | unit, Central Processing |
| | Unit |
| C/R | Command/Response |
| | field bit |
| CRAN | Cloud Radio |
| | Access Network, |
| | Cloud RAN |
| CRB | Common Resource |
| | Block |
| CRC | Cyclic Redundancy |
| | Check |
| CRI | Channel-State |
| | Information Resource |
| | Indicator, CSI-RS |
| | Resource Indicator |
| C-RNTI | Cell RNTI |
| CS | Circuit Switched |
| CSCF | call session |
| | control function |
| CSAR | Cloud Service |
| | Archive |
| CSI | Channel-State |
| | Information |
| CSI-IM | CSI |
| | Interference |
| | Measurement |
| CSI-RS | CSI |
| | Reference Signal |
| CSI-RSRP | CSI |
| | reference signal |
| | received power |
| CSI-RSRQ | CSI |
| | reference signal |
| | received quality |
| CSI-SINR | CSI signal-to-noise |
| | and interference |
| | ratio |
| CSMA | Carrier Sense |
| | Multiple Access |
| CSMA/CA | CSMA with |
| | collision avoidance |
| CSS | Common Search |
| | Space, Cell- specific |
| | Search Space |
| CTF | Charging |
| | Trigger Function |
| CTS | Clear-to-Send |
| CW | Codeword |
| CWS | Contention |
| | Window Size |
| D2D | Device-to-Device |
| DC | Dual Connectivity, |
| Direct | Current |
| DCI | Downlink Control |
| | Information |
| DF | Deployment |
| | Flavour |
| DL | Downlink |
| DMTF | Distributed |
| | Management Task Force |
| DPDK | Data Plane |
| | Development Kit |
| DM-RS, | Demodulation |
| DMRS | Reference Signal |
| DN | Data network |
| DNN | Data Network Name |
| DNAI | Data Network |
| | Access Identifier |
| DRB | Data Radio Bearer |
| DRS | Discovery |
| | Reference Signal |
| DRX | Discontinuous |
| | Reception |
| DSL | Domain Specific |
| | Language. Digital |
| | Subscriber Line |
| DSLAM | DSL Access Multiplexer |
| DwPTS | Downlink Pilot Time |
| | Slot |
| E-LAN | Ethernet Local Area |
| | Network |
| E2E | End-to-End |
| EAS | Edge Application |
| | Server |
| ECCA | extended clear channel |
| | assessment, extended |
| | CCA ECCE Enhanced |
| | Control Channel |
| | Element, Enhanced CCE |
| ED | Energy Detection |
| EDGE | Enhanced Datarates |
| | for GSM Evolution |
| | (GSM Evolution) |
| EAS | Edge |
| | Application Server |
| EASID | Edge |
| | Application Server |
| | Identification |
| ECS | Edge |
| | Configuration Server |
| ECSP | Edge |
| | Computing Service |
| | Provider |
| EDN | Edge Data |
| | Network |
| EEC | Edge |
| | Enabler Client |
| EECID | Edge |
| | Enabler Client |
| | Identification |
| EES | Edge |
| | Enabler Server |
| EESID | Edge |
| | Enabler Server |
| | Identification |
| EHE | Edge |
| | Hosting Environment |
| EGMF | Exposure |
| | Governance |
| | Management |
| | Function |
| EGPRS | Enhanced GPRS |
| EIR | Equipment Identity |
| | Register |
| eLAA | enhanced Licensed |
| | Assisted Access, |
| | enhanced LAA |
| EM | Element Manager |
| eMBB | Enhanced Mobile |
| | Broadband |
| EMS | Element Management |
| | System |
| eNB | evolved NodeB, E- |
| | UTRAN Node B |
| EN-DC | E-UTRA-NR Dual |
| | Connectivity |
| EPC | Evolved Packet Core |
| EPDCCH | enhanced |
| | PDCCH, enhanced |
| | Physical Downlink |
| | Control Cannel |
| EPRE | Energy per resource |
| | element |
| EPS | Evolved Packet System |
| EREG | enhanced REG, |
| | enhanced resource |
| | element groups |
| ETSI | European |
| | Telecommunications |
| | Standards Institute |
| ETWS | Earthquake and |
| | Tsunami Warning |
| | System |
| eUICC | embedded UICC, |
| | embedded Universal |
| | Integrated Circuit Card |
| E-UTRA | Evolved UTRA |
| E-UTRAN | Evolved UTRAN |
| EV2X | Enhanced V2X |
| F1AP | F1 Application |
| | Protocol |
| F1-C | F1 Control plane |
| | interface |
| F1-U | F1 User plane |
| | interface |
| FACCH | Fast |
| | Associated Control |
| | CHannel |
| FACCH/F | Fast |
| | Associated Control |
| | Channel/Full rate |
| FACCH/H | Fast |
| | Associated Control |
| | Channel/Half rate |
| FACH | Forward Access |
| | Channel |
| FAUSCH | Fast Uplink |
| | Signalling Channel |
| FB | Functional Block |
| FBI | Feedback Information |
| FCC | Federal |
| | Communications |
| | Commission |
| FCCH | Frequency |
| | Correction CHannel |
| FDD | Frequency Division |
| | Duplex |
| FDM | Frequency Division |
| | Multiplex |
| FDMA | Frequency Division |
| | Multiple Access |
| FE | Front End |
| FEC | Forward Error |
| | Correction |
| FFS | For Further Study |
| FFT | Fast Fourier |
| | Transformation |
| feLAA | further enhanced |
| | Licensed Assisted |
| | Access, further |
| | enhanced LAA |
| FN | Frame Number |
| FPGA | Field- |
| | Programmable Gate |
| | Array |
| FR | Frequency Range |
| FQDN | Fully Qualified |
| | Domain Name |
| G-RNTI | GERAN |
| | Radio Network |
| | Temporary Identity |
| GERAN | GSM EDGE RAN, |
| | GSM EDGE Radio |
| | Access Network |
| GGSN | Gateway GPRS |
| | Support Node |
| GLONASS | GLObal'naya |
| | NAvigatsionnaya |
| | Sputnikovaya |
| | Sistema (Engl.: |
| | Global Navigation |
| | Satellite System) |
| gNB | Next Generation |
| | NodeB |
| gNB-CU | gNB- |
| | centralized unit, Next |
| | Generation NodeB |
| | centralized unit |
| gNB-DU | gNB- |
| | distributed unit, Next |
| | Generation NodeB |
| | distributed unit |
| GNSS | Global Navigation |
| | Satellite System |
| GPRS | General Packet |
| | Radio Service |
| GPSI | Generic |
| | Public Subscription |
| | Identifier |
| GSM | Global System for |
| | Mobile |
| | Communications, |
| | Groupe Special |
| | Mobile |
| GTP | GPRS Tunneling |
| | Protocol |
| GTP-UGPRS | Tunnelling |
| | Protocol for User |
| | Plane |
| GTS | Go To Sleep Signal |
| | (related to WUS) |
| GUMMEI | Globally |
| | Unique MME Identifier |
| GUTI | Globally Unique |
| | Temporary UE Identity |
| HARQ | Hybrid ARQ, |
| | Hybrid Automatic |
| | Repeat Request |
| HANDO | Handover |
| HFN | HyperFrame |
| | Number |
| HHO | Hard Handover |
| HLR | Home Location |
| | Register |
| HN | Home Network |
| HO | Handover |
| HPLMN | Home |
| | Public Land Mobile |
| | Network |
| HSDPA | High Speed |
| | Downlink Packet |
| | Access |
| HSN | Hopping Sequence |
| | Number |
| HSPA | High Speed Packet |
| | Access |
| HSS | Home Subscriber Server |
| HSUPA | High Speed |
| | Uplink Packet Access |
| HTTP | Hyper Text |
| | Transfer Protocol |
| HTTPS | Hyper Text |
| | Transfer Protocol |
| | Secure (https is |
| | http/1.1 over SSL, |
| | i.e. port 443) |
| I-Block | Information Block |
| ICCID | Integrated Circuit |
| | Card Identification |
| IAB | Integrated Access |
| | and Backhaul |
| ICIC | Inter-Cell Interference |
| | Coordination |
| ID | Identity, identifier |
| IDFT | Inverse Discrete |
| | Fourier Transform |
| IE | Information |
| | element |
| IBE | In-Band Emission |
| IEEE | Institute of |
| | Electrical and Electronics |
| | Engineers |
| IEI | Information |
| | Element Identifier |
| IEIDL | Information |
| | Element Identifier |
| | Data Length |
| IETF | Internet |
| | Engineering Task |
| | Force |
| IF | Infrastructure |
| IIOT | Industrial Internet |
| | of Things |
| IM | Interference |
| | Measurement, |
| | Intermodulation, IP |
| | Multimedia |
| IMC | IMS Credentials |
| IMEI | International |
| | Mobile Equipment |
| | Identity |
| IMGI | International |
| | mobile group identity |
| IMPI | IP Multimedia |
| | Private Identity |
| IMPU | IP Multimedia |
| | PUblic identity |
| IMS | IP Multimedia |
| | Subsystem |
| IMSI | International |
| | Mobile Subscriber |
| | Identity |
| IOT | Internet of Things |
| IP | Internet Protocol |
| Ipsec | IP Security, |
| | Internet Protocol |
| | Security |
| IP-CAN | IP-Connectivity |
| | Access Network |
| IP-M | IP Multicast |
| IPv4 | Internet Protocol |
| | Version 4 |
| IPV6 | Internet Protocol |
| | Version 6 |
| IR | Infrared |
| IS | In Sync |
| IRP | Integration |
| | Reference Point |
| ISDN | Integrated Services |
| | Digital Network |
| ISIM | IM Services |
| | Identity Module |
| ISO | International |
| | Organisation for |
| | Standardisation |
| ISP | Internet Service |
| | Provider |
| IWF | Interworking- |
| | Function |
| I-WLAN | Interworking WLAN |
| | Constraint length of |
| | the convolutional code, |
| | USIM Individual key |
| | KB Kilobyte (1000 |
| | bytes) |
| kbps | kilo-bits per second |
| Kc | Ciphering key |
| Ki | Individual subscriber |
| | authentication key |
| KPI | Key Performance |
| | Indicator |
| KQI | Key Quality |
| | Indicator |
| KSI | Key Set Identifier |
| ksps | kilo-symbols per |
| | second |
| KVM | Kernel Virtual |
| | Machine |
| L1 | Layer 1 (physical layer) |
| L1-RSRP | Layer 1 reference |
| | signal received power |
| L2 | Layer 2 (data link layer) |
| L3 | Layer 3 (network layer) |
| LAA | Licensed Assisted |
| | Access |
| LAN | Local Area Network |
| LADN | Local Area Data |
| | Network |
| LBT | Listen Before Talk |
| LCM | LifeCycle |
| | Management |
| LCR | Low Chip Rate |
| LCS | Location Services |
| LCID | Logical Channel ID |
| LI | Layer Indicator |
| LLC | Logical Link |
| | Control, Low Layer |
| | Compatibility |
| LMF | Location |
| | Management Function |
| LOS | Line of Sight |
| LPLMN | Local PLMN |
| LPP | LTE Positioning |
| | Protocol |
| LSB | Least Significant Bit |
| LTE | Long Term Evolution |
| LWA | LTE-WLAN |
| | aggregation |
| LWIP | LTE/WLAN Radio |
| | Level Integration with |
| | IPsec Tunnel |
| LTE | Long Term Evolution |
| M2M | Machine-to-Machine |
| MAC | Medium Access |
| | Control (protocol |
| | layering context) |
| MAC | Message |
| | authentication code |
| | (security/encryption |
| | context) |
| MAC-A | MAC used |
| | for authentication and |
| | key agreement (TSG T |
| | WG3 context) |
| MAC-IMAC | used for data |
| | integrity of |
| | signalling messages (TSG |
| | T WG3 context) |
| MANO | Management and |
| | Orchestration |
| MBMS | Multimedia |
| | Broadcast and Multicast |
| | Service |
| MBSFN | Multimedia |
| | Broadcast multicast |
| | service Single Frequency |
| | Network |
| MCC | Mobile Country Code |
| MCG | Master Cell Group |
| MCOT | Maximum Channel |
| | Occupancy Time |
| MCS | Modulation and |
| | coding scheme |
| MDAF | Management Data |
| | Analytics Function |
| MDAS | Management Data |
| | Analytics Service |
| MDT | Minimization of |
| | Drive Tests |
| ME | Mobile Equipment |
| MeNB | master eNB |
| MER | Message Error Ratio |
| MGL | Measurement Gap |
| | Length |
| MGRP | Measurement Gap |
| | Repetition Period |
| MIB | Master Information |
| | Block, Management |
| | Information Base |
| MIMO | Multiple Input |
| | Multiple Output |
| MLC | Mobile Location Centre |
| MM | Mobility Management |
| MME | Mobility Management |
| | Entity |
| MN | Master Node |
| MNO | Mobile Network |
| | Operator |
| MO | Measurement Object, |
| | Mobile Originated |
| MPBCH | MTC Physical |
| | Broadcast CHannel |
| MPDCCH | MTC |
| | Physical Downlink |
| | Control CHannel |
| MPDSCH | MTC |
| | Physical Downlink |
| | Shared CHannel |
| MPRACH | MTC Physical Random |
| | Access CHannel |
| MPUSCH | MTC Physical Uplink |
| | Shared Channel |
| MPLS | MultiProtocol |
| | Label Switching |
| MS | Mobile Station |
| MSB | Most Significant Bit |
| MSC | Mobile Switching |
| | Centre |
| MSI | Minimum System |
| | Information, MCH |
| | Scheduling |
| | Information |
| MSID | Mobile Station |
| | Identifier |
| MSIN | Mobile Station |
| | Identification |
| | Number |
| MSISDN | Mobile Subscriber |
| | ISDN Number |
| MT | Mobile Terminated, |
| | Mobile Termination |
| MTC | Machine-Type |
| | Communications |
| mMTC | massive MTC, |
| | massive Machine- |
| | Type Communications |
| MU-MIMO | Multi User |
| | MIMO |
| MWUS | MTC wake- |
| | up signal, MTC WUS |
| NACK | Negative |
| | Acknowledgement |
| NAI | Network Access |
| | Identifier |
| NAS | Non-Access |
| | Stratum, Non- Access |
| | Stratum layer |
| NCT | Network |
| | Connectivity Topology |
| NC-JT | Non-Coherent |
| | Joint Transmission |
| NEC | Network Capability |
| | Exposure |
| NE-DC | NR-E- |
| | UTRA Dual |
| | Connectivity |
| NEF | Network Exposure |
| | Function |
| NF | Network Function |
| NFP | Network |
| | Forwarding Path |
| NFPD | Network |
| | Forwarding Path |
| | Descriptor |
| NFV | Network Functions |
| | Virtualization |
| NFVI | NFV Infrastructure |
| NFVO | NFV Orchestrator |
| NG | Next Generation, |
| | Next Gen |
| NGEN-DC | NG-RAN |
| | E-UTRA-NR Dual |
| | Connectivity |
| NM | Network Manager |
| NMS | Network |
| | Management System |
| N-POP | Network Point of |
| | Presence |
| NMIB, N-MIB | Narrowband MIB |
| NPBCH | Narrowband |
| | Physical Broadcast |
| | CHannel |
| NPDCCH | Narrowband |
| | Physical Downlink |
| | Control CHannel |
| NPDSCH | Narrowband |
| | Physical Downlink |
| | Shared CHannel |
| NPRACH | Narrowband |
| | Physical Random |
| | Access CHannel |
| NPUSCH | Narrowband |
| | Physical Uplink |
| | Shared CHannel |
| NPSS | Narrowband |
| | Primary |
| | Synchronization |
| | Signal |
| NSSS | Narrowband |
| | Secondary |
| | Synchronization |
| | Signal |
| NR | New Radio, |
| | Neighbour Relation |
| NRF | NF Repository |
| | Function |
| NRS | Narrowband |
| | Reference Signal |
| NS | Network Service |
| NSA | Non-Standalone |
| | operation mode |
| NSD | Network Service |
| | Descriptor |
| NSR | Network Service |
| | Record |
| NSSAI | Network Slice |
| | Selection Assistance |
| | Information |
| S-NNSAI | Single- |
| | NSSAI |
| NSSF | Network Slice |
| | Selection Function |
| NW | Network |
| NWUS | Narrowband wake- |
| | up signal, Narrowband |
| | WUS |
| NZP | Non-Zero Power |
| O&M | Operation and |
| | Maintenance |
| ODU2 | Optical channel |
| | Data Unit-type 2 |
| OFDM | Orthogonal |
| | Frequency Division |
| | Multiplexing |
| OFDMA | Orthogonal |
| | Frequency Division |
| | Multiple Access |
| OOB | Out-of-band |
| OOS | Out of Sync |
| OPEX | OPerating EXpense |
| OSI | Other System |
| | Information |
| OSS | Operations Support |
| | System |
| OTA | over-the-air |
| PAPR | Peak-to-Average |
| | Power Ratio |
| PAR | Peak to Average |
| | Ratio |
| PBCH | Physical Broadcast |
| | Channel |
| PC | Power Control, |
| | Personal Computer |
| PCC | Primary |
| | Component Carrier, |
| | Primary CC |
| P-CSCF | Proxy CSCF |
| PCell | Primary Cell |
| PCI | Physical Cell ID, |
| | Physical Cell |
| | Identity |
| PCEF | Policy and Charging |
| | Enforcement Function |
| PCF | Policy Control |
| | Function |
| PCRF | Policy Control and |
| | Charging Rules |
| | Function |
| PDCP | Packet Data |
| | Convergence Protocol, |
| | Packet Data |
| | Convergence |
| | Protocol layer |
| PDCCH | Physical |
| | Downlink Control |
| | Channel |
| PDCP | Packet Data |
| | Convergence Protocol |
| PDN | Packet Data |
| | Network, Public Data |
| | Network |
| PDSCH | Physical |
| | Downlink Shared |
| | Channel |
| PDU | Protocol Data Unit |
| PEI | Permanent |
| | Equipment Identifiers |
| PFD | Packet Flow |
| | Description |
| P-GW | PDN Gateway |
| PHICH | Physical |
| | hybrid-ARQ indicator |
| | channel |
| PHY | Physical layer |
| PLMN | Public Land Mobile |
| | Network |
| PIN | Personal |
| | Identification Number |
| PM | Performance |
| | Measurement |
| PMI | Precoding Matrix |
| | Indicator |
| PNF | Physical Network |
| | Function |
| PNFD | Physical Network |
| | Function Descriptor |
| PNFR | Physical Network |
| | Function Record |
| POC | PTT over Cellular |
| PP, PTP | Point-to-Point |
| PPP | Point-to-Point |
| | Protocol |
| PRACH | Physical RACH |
| PRB | Physical resource |
| | block |
| PRG | Physical resource |
| | block group |
| ProSe | Proximity Services, |
| | Proximity-Based |
| | Service |
| PRS | Positioning |
| | Reference Signal |
| PRR | Packet Reception |
| | Radio |
| PS | Packet Services |
| PSBCH | Physical |
| | Sidelink Broadcast |
| | Channel |
| PSDCH | Physical Sidelink |
| | Downlink Channel |
| PSCCH | Physical Sidelink Control |
| | Channel |
| PSSCH | Physical Sidelink Shared |
| | Channel |
| PSFCH | physical sidelink |
| | feedback channel |
| PSCell | Primary SCell |
| PSS | Primary |
| | Synchronization |
| | Signal |
| PSTN | Public Switched |
| | Telephone Network |
| PT-RS | Phase-tracking |
| | reference signal |
| PTT | Push-to-Talk |
| PUCCH | Physical |
| | Uplink Control |
| | Channel |
| PUSCH | Physical Uplink Shared |
| | Channel |
| QAM | Quadrature Amplitude |
| | Modulation |
| QCI | QoS class of identifier |
| QCL | Quasi co-location |
| QFI | QOS Flow ID, QoS |
| | Flow Identifier |
| QOS | Quality of Service |
| QPSK | Quadrature |
| | (Quaternary) Phase Shift |
| | Keying |
| QZSS | Quasi-Zenith |
| | Satellite System |
| RA-RNTI | Random |
| | Access RNTI |
| RAB | Radio Access |
| | Bearer, Random |
| | Access Burst |
| RACH | Random Access |
| | Channel |
| RADIUS | Remote Authentication |
| | Dial In User Service |
| RAN | Radio Access Network |
| RAND | RANDom number |
| | (used for authentication) |
| RAR | Random Access |
| | Response |
| RAT | Radio Access |
| | Technology |
| RAU | Routing Area Update |
| RB | Resource block, Radio |
| | Bearer |
| RBG | Resource block group |
| REG | Resource Element |
| | Group |
| Rel | Release |
| REQ | REQuest |
| RF | Radio Frequency |
| RI | Rank Indicator |
| RIV | Resource indicator |
| | value |
| RL | Radio Link |
| RLC | Radio Link |
| | Control, Radio Link |
| | Control layer |
| RLC AM | RLC Acknowledged |
| | Mode |
| RLC UM | RLC Unacknowledged |
| | Mode |
| RLF | Radio Link Failure |
| RLM | Radio Link Monitoring |
| RLM-RS | Reference |
| | Signal for RLM |
| RM | Registration |
| | Management |
| RMC | Reference |
| | Measurement Channel |
| RMSI | Remaining MSI, |
| | Remaining Minimum |
| | System Information |
| RN | Relay Node |
| RNC | Radio Network |
| | Controller |
| RNL | Radio Network Layer |
| RNTI | Radio Network |
| | Temporary Identifier |
| ROHC | RObust Header |
| | Compression |
| RRC | Radio Resource |
| | Control, Radio |
| | Resource Control layer |
| RRM | Radio Resource |
| | Management |
| RS | Reference Signal |
| RSRP | Reference Signal |
| | Received Power |
| RSRQ | Reference Signal |
| | Received Quality |
| RSSI | Received Signal |
| | Strength Indicator |
| RSU | Road Side Unit |
| RSTD | Reference Signal |
| | Time difference |
| RTP | Real Time Protocol |
| RTS | Ready-To-Send |
| RTT | Round Trip Time |
| | Rx Reception, |
| | Receiving, Receiver |
| S1AP | S1 Application |
| | Protocol |
| S1-MME | S1 for the control |
| | plane |
| S1-U | S1 for the user plane |
| S-CSCF | serving CSCF |
| S-GW | Serving Gateway |
| S-RNTI | SRNC |
| | Radio Network |
| | Temporary Identity |
| S-TMSI | SAE |
| | Temporary Mobile |
| | Station Identifier |
| SA | Standalone |
| | operation mode |
| SAE | System |
| | Architecture Evolution |
| SAP | Service Access |
| | Point |
| SAPD | Service Access |
| | Point Descriptor |
| SAPI | Service Access |
| | Point Identifier |
| SCC | Secondary |
| | Component Carrier, |
| | Secondary CC |
| SCell | Secondary Cell |
| SCEF | Service |
| | Capability Exposure |
| | Function |
| SC-FDMA | Single Carrier |
| | Frequency Division |
| | Multiple Access |
| SCG | Secondary Cell Group |
| SCM | Security Context |
| | Management |
| SCS | Subcarrier Spacing |
| SCTP | Stream Control |
| | Transmission Protocol |
| SDAP | Service Data |
| | Adaptation Protocol, |
| | Service Data Adaptation |
| | Protocol layer |
| SDL | Supplementary |
| | Downlink |
| SDNF | Structured Data |
| | Storage Network |
| | Function |
| SDP | Session Description |
| | Protocol |
| SDSF | Structured Data |
| | Storage Function |
| SDT | Small Data |
| | Transmission |
| SDU | Service Data Unit |
| SEAF | Security Anchor |
| | Function |
| SeNB | secondary eNB |
| SEPP | Security Edge |
| | Protection Proxy |
| SFI | Slot format |
| | indication |
| SFTD | Space-Frequency |
| | Time Diversity, SFN and |
| | frame timing difference |
| SFN | System Frame |
| | Number |
| SgNB | Secondary gNB |
| SGSN | Serving GPRS |
| | Support Node |
| S-GW | Serving Gateway |
| SI | System Information |
| SI-RNTI | System |
| | Information RNTI |
| SIB | System Information |
| | Block |
| SIM | Subscriber Identity |
| | Module |
| SIP | Session Initiated |
| | Protocol |
| SiP | System in Package |
| SL | Sidelink |
| SLA | Service Level Agreement |
| SM | Session Management |
| SMF | Session Management |
| | Function |
| SMS | Short Message Service |
| SMSF | SMS Function |
| SMTC | SSB-based |
| | Measurement Timing |
| | Configuration |
| SN | Secondary Node, |
| | Sequence Number |
| SoC | System on Chip |
| SON | Self-Organizing |
| | Network |
| SpCell | Special Cell |
| SP-CSI-RNTI | Semi-Persistent |
| | CSI RNTI |
| SPS | Semi-Persistent |
| | Scheduling |
| SQN | Sequence number |
| SR | Scheduling Request |
| SRB | Signalling Radio |
| | Bearer |
| SRS | Sounding |
| | Reference Signal |
| SS | Synchronization |
| | Signal |
| SSB | Synchronization |
| | Signal Block |
| SSID | Service Set Identifier |
| SS/PBCH | Block |
| | SSBRI SS/PBCH Block |
| | Resource Indicator, |
| | Synchronization |
| | Signal Block |
| | Resource Indicator |
| SSC | Session and Service |
| | Continuity |
| SS-RSRP | Synchronization |
| | Signal based Reference |
| | Signal Received Power |
| SS-RSRQ | Synchronization |
| | Signal based Reference |
| | Signal Received |
| | Quality |
| SS-SINR | Synchronization |
| | Signal based Signal to |
| | Noise and Interference |
| | Ratio |
| SSS | Secondary |
| | Synchronization |
| | Signal |
| SSSG | Search Space Set Group |
| SSSIF | Search Space Set |
| | Indicator |
| SST | Slice/Service Types |
| SU-MIMO | Single User MIMO |
| SUL | Supplementary Uplink |
| TA | Timing Advance, |
| | Tracking Area |
| TAC | Tracking Area Code |
| TAG | Timing Advance Group |
| TAI | Tracking Area Identity |
| TAU | Tracking Area Update |
| TB | Transport Block |
| TBS | Transport Block Size |
| TBD | To Be Defined |
| TCI | Transmission |
| | Configuration Indicator |
| TCP | Transmission |
| | Communication |
| | Protocol |
| TDD | Time Division Duplex |
| TDM | Time Division |
| | Multiplexing |
| TDMA | Time Division Multiple |
| | Access |
| TE | Terminal Equipment |
| TEID | Tunnel End Point |
| | Identifier |
| TFT | Traffic Flow Template |
| TMSI | Temporary Mobile |
| | Subscriber Identity |
| TNL | Transport Network |
| | Layer |
| TPC | Transmit Power |
| | Control |
| TPMI | Transmitted Precoding |
| | Matrix Indicator |
| TR | Technical Report |
| TRP, TRxP | Transmission |
| | Reception Point |
| TRS | Tracking Reference |
| | Signal |
| TRx | Transceiver |
| TS | Technical |
| | Specifications, |
| | Technical Standard |
| TTI | Transmission Time |
| | Interval |
| Tx | Transmission, |
| | Transmitting, |
| | Transmitter |
| U-RNTI | UTRAN Radio |
| | Network Temporary |
| | Identity |
| UART | Universal |
| | Asynchronous |
| | Receiver and |
| | Transmitter |
| UCI | Uplink Control |
| | Information |
| UE | User Equipment |
| UDM | Unified Data |
| | Management |
| UDP | User Datagram |
| | Protocol |
| UDSF | Unstructured Data |
| | Storage Network |
| | Function |
| UICC | Universal |
| | Integrated Circuit Card |
| UL | Uplink |
| UM | Unacknowledged |
| | Mode |
| UML | Unified Modelling |
| | Language |
| UMTS | Universal Mobile |
| | Telecommunications |
| | System |
| UP | User Plane |
| UPF | User Plane Function |
| URI | Uniform Resource |
| | Identifier |
| URL | Uniform Resource |
| | Locator |
| URLLC | Ultra-Reliable and |
| | Low Latency |
| USB | Universal Serial Bus |
| USIM | Universal Subscriber |
| | Identity Module |
| USS | UE-specific search |
| | space |
| UTRA | UMTS Terrestrial |
| | Radio Access |
| UTRAN | Universal Terrestrial |
| | Radio Access Network |
| UwPTS | Uplink Pilot Time Slot |
| V2I | Vehicle-to- |
| | Infrastruction |
| V2P | Vehicle-to- |
| | Pedestrian |
| V2V | Vehicle-to-Vehicle |
| V2X | Vehicle-to- |
| | everything |
| VIM | Virtualized |
| | Infrastructure Manager |
| VL | Virtual Link, |
| VLAN | Virtual LAN, Virtual |
| | Local Area Network |
| VM | Virtual Machine |
| VNF | Virtualized |
| | Network Function |
| VNFFG | VNF |
| | Forwarding Graph |
| VNFFGD | VNF |
| | Forwarding Graph |
| | Descriptor |
| VNFM | VNF Manager |
| VoIP | Voice-over-IP, |
| | Voice-over-Internet |
| | Protocol |
| VPLMN | Visited Public |
| | Land Mobile Network |
| VPN | Virtual Private |
| | Network |
| VRB | Virtual Resource |
| | Block |
| WiMAX | Worldwide |
| | Interoperability for |
| | Microwave Access |
| WLAN | Wireless Local |
| | Area Network |
| WMAN | Wireless Metropolitan |
| | Area Network |
| WPAN | Wireless Personal |
| | Area Network |
| X2-C | X2-Control plane |
| X2-U | X2-User plane |
| XML | eXtensible Markup |
| | Language |
| XRES | EXpected user |
| | RESponse |
| XOR | eXclusive OR |
| ZC | Zadoff-Chu |
| ZP | Zero Power |

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1. An electronic device comprising:
one or more processors; and
one or more non-transitory computer-readable media comprising instructions that, upon execution of the instructions by the one or more processors, are to cause a content provider in a network to:
identify a request by a client over the network for content;
identify a network bandwidth; and
transmit, based on the network bandwidth, (1) a base layer of the content without an enhanced layer of the content, or (2) the base layer of the content and the enhanced layer of the content.

2. The electronic device of claim 1, wherein the content is encoded in accordance with scalable video coding (SVC).

3. The electronic device of claim 2, wherein the SVC encoding includes anchor frames.

4. The electronic device of claim 1, wherein the content is transmitted based on hypertext transfer protocol (HTTP) adaptive bitrate (ABR) streaming.

5. The electronic device of claim 4, wherein the HTTP ABR protocol includes support for one or both of layered renditions and layered representation.

6. The electronic device of claim 1, wherein the enhanced layer of the content has a bit rate that is higher than that of the base layer of content.

7. The electronic device of claim 1, wherein, if the base layer and the enhanced layer are transmitted, the base layer and enhanced layer are transmitted in concurrent communication channels.

8. The electronic device of claim 1, wherein the enhanced layer is one of a plurality of enhanced layers that have respective bit rates that are higher than a bit rate of the base layer.

9. An electronic device comprising:
one or more processors; and
one or more non-transitory computer-readable media comprising instructions that, upon execution of the instructions by the one or more processors, are to cause a client in a network to:
request content from a content provider; and
identify, based on the request, data related to the content;
wherein, based on the bandwidth of the network, the data includes (1) a base layer of the content without an enhanced layer of the content, or (2) the base layer of the content and the enhanced layer of the content.

10. The electronic device of claim 9, wherein the content is encoded in accordance with scalable video coding (SVC).

11. The electronic device of claim 10, wherein the SVC encoding includes anchor frames.

12. The electronic device of claim 9, wherein the content is transmitted based on hypertext transfer protocol (HTTP) adaptive bitrate (ABR) streaming.

13. The electronic device of claim 12, wherein the HTTP ABR protocol includes support for one or both of layered renditions and layered representation.

14. The electronic device of claim 9, wherein the enhanced layer of the content has a bit rate that is higher than that of the base layer of the content.

15. The electronic device of claim 9, wherein, if the base layer and the enhanced layer are transmitted, the base layer and enhanced layer are transmitted in concurrent communication channels.

16. The electronic device of claim 9, wherein the enhanced layer is one of a plurality of enhanced layers that have respective bit rates that are higher than a bit rate of the base layer.

17. One or more non-transitory computer-readable media comprising instructions that, upon execution of the instructions by one or more processors, are to cause a content provider in a network to:
identify a request by a client over the network for content;
identify a network bandwidth; and
transmit, based on the network bandwidth, (1) a base layer of the content without an enhanced layer of the content, or (2) the base layer of the content and the enhanced layer of the content.

18. The one or more non-transitory computer-readable media of claim 17, wherein the enhanced layer of the content has a bit rate that is higher than that of the base layer of content.

19. The one or more non-transitory computer-readable media of claim 17, wherein, if the base layer and the enhanced layer are transmitted, the base layer and enhanced layer are transmitted in concurrent communication channels.

20. The one or more non-transitory computer-readable media of claim 17, wherein the enhanced layer is one of a plurality of enhanced layers that have respective bit rates that are higher than a bit rate of the base layer.
